(19) United States
(12) Patent Application Publication
(10) Pub. No.: US 2026/0235088 A1
(43) Pub. Date: Aug. 13, 2026

(54) METHOD AND PROCESSING ARRANGEMENT FOR CONTROLLING A PERMISSION TO CRANK AN ENGINE

(71) Applicant: Scania CV AB, Södertälje (SE)

(72) Inventors: Marcus GRALDE STÅLHANDSKE, Trångsund (SE); Ludvig ADLERCREUTZ, Tullinge (SE); Fredrik PETTERSSON, Nykvarn (SE)

(73) Assignee: Scania CV AB, Södertälje (SE)

(21) Appl. No.: 19/153,685

(22) PCT Filed: Feb. 6, 2024
(86) PCT No.: PCT/SE2024/050102

§ 371 Date: Aug. 5, 2025

(30) Foreign Application Priority Data
Feb. 20, 2023 (SE) 2350191-9

(51) Int. Cl. F02D 41/06; F02D 41/00; F02M 21/02; F02P 5/15; G05B 15/02

(52) U.S. Cl. CPC F02D 41/062; F02D 41/0027; F02M 21/0221; F02M 21/0239; F02P 5/1506; G05B 15/02; F02D 2200/0602

(57) ABSTRACT

A method for controlling a permission to crank an engine is presented, the engine comprising a gas fuel system comprising: one or more controllable valves to provide fuel to a regulator at an upstream pressure (P2); the regulator arranged to regulate the upstream pressure (P2) of the fuel down to a lower working pressure (P3); a low pressure valve arranged downstream of the regulator; and a working pressure sensor arranged at the engine. The method comprises: closing the low pressure valve; controlling at least one of the controllable valves such that the gas fuel system is pressurized upstream of the low pressure valve; opening the low pressure valve; monitoring, by use of the working pressure sensor, an increase of the working pressure (ΔP3) after the opening of the low pressure valve; and controlling a permission to crank the engine based on the monitored increase of the working pressure (ΔP3).

### TECHNICAL FIELD

The present invention relates to safety measures related to gas fuel driven engines, and in particular to methods and processing arrangements for controlling a permission to crank gas fuel driven engines. The present invention also relates to a computer program and a computer-readable medium that implement the methods according to the invention.

### BACKGROUND

The following background description constitutes a description of the background to the present invention, which does not, however, necessarily have to constitute prior art.

An engine may be driven by a gas fuel of some kind, such as methane gas fuel or hydrogen gas fuel. Such gas fuels may include, among others compressed natural gas (CNG) fuel, liquified natural gas (LNG) fuel and/or liquefied petrol gas (LPG) fuel. The engine is here provided with the gas by a gas fuel system. The gas fuel system may therefore comprise one or more fuel tanks, a number of valves, piping/hoses, pressure sensors, filters, and injectors arranged for providing the gas fuel into the cylinders of the engine. The gas fuel system further comprises at least one regulator arranged to regulate a higher storage or upstream pressure of the gaseous fuel down to a lower working pressure adapted to the capabilities of the components downstream of the at least one regulator. Due to space limitations, e.g. in gas fuel driven vehicles, the fuel in the fuel tanks is stored at a high storage pressure to reduce the volume of the fuel and thereby also of the tanks. Thus, the function of the at least one regulator is to reduce the higher storage or upstream pressure down to a suitable downstream working pressure, such that the downstream components can work efficiently without being damaged by high pressures.

### BRIEF DESCRIPTION OF THE INVENTION

A regulator in a gas fuel system commonly comprises an actuator moving within a regulator body, e.g. due to counteracting forces created by the working pressure of the gas fuel and a by a regulator spring arrangement of some kind. Hereby, surfaces of the moving actuator and the inner regulator body may in certain situations, for example when the regulator is in an open position, come in contact with each other. If one or more of these surfaces are soiled, e.g. coated with oil or grease, the surfaces may stick together due to a vacuum created when they come in contact with each other. The surfaces will then be difficult to pull apart, and the regulator may be stuck in the open position. A situation when this problem may occur is when the gas fuel system has been emptied during maintenance, whereby the regulator is completely opened. Another possible situation when this may occur is when the engine runs at very high loads when the fuel tanks are almost empty, i.e. when the storage pressure is low. When this problem occurs, the regulator is thus stuck in an open position and cannot regulate the pressure.

The regulator may also be stuck in an open position if it is broken, for example if its regulator spring arrangement is broken.

If cranking is attempted when the regulator is stuck open, there is a considerable risk for damages of one or more components downstream of the regulator. These downstream components, such as for example filters, injectors and/or piping/hoses, are designed for coping with the lower working pressure normally provided by the regulator. However, if cranking is initiated when the regulator is stuck in its open position, all valves between the gas fuel tanks and the engine are opened, which causes the downstream working pressure to rapidly become very high due to the stuck-open regulator, thereby possibly quickly rising to a level corresponding to the storage pressure in the gas fuel tanks. Thus, the downstream components, that are designed for considerably lower working pressures, are then exposed to quickly increasing, and also very high, pressures, at levels corresponding to the storage pressure used for storing the gas in the fuel tanks.

There is therefore a considerable risk that the downstream arranged components will burst, or be damaged in another way, because of the high pressure they are being exposed to. Such component bursting or damaging may cause vehicle off road time, as well as hearing impairment and/or other injuries of a driver of the vehicle or of a technician working on the vehicle.

It would be advantageous to achieve a method and processing arrangement overcoming, or at least alleviating, at least some of the above mentioned drawbacks. In particular, it would be desirable to enable a method and processing arrangement reducing damages and/or increasing safety. To better address one or more of these concerns, a method, a processing arrangement, a computer program, a computer-readable medium and a vehicle having the features defined in the independent claims are provided.

According to an aspect of the present invention, this objective is achieved through the above-mentioned method for controlling a permission to crank an engine, where the engine is configured to be provided with a gas fuel by a gas fuel system.

The gas fuel system comprises:
one or more fuel tanks configured to store the fuel at a storage pressure;
one or more controllable valves arranged downstream of the one or more fuel tanks, respectively, to provide the fuel to at least one regulator at an upstream pressure;
the at least one regulator arranged downstream of the one or more controllable valves to regulate the upstream pressure of the fuel down to a lower working pressure;
a low pressure valve arranged downstream of the at least one regulator;
one or more components arranged downstream of the low pressure valve to provide the fuel to the engine at the working pressure; and
at least one working pressure sensor arranged at the engine; the method comprising the steps of:
closing the low pressure valve;
controlling at least one of the one or more controllable valves such that the gas fuel system is pressurized upstream of the low pressure valve;
opening the low pressure valve;
monitoring, by use of the at least one working pressure sensor, an increase of the working pressure after the opening of the low pressure valve; and
controlling a permission to crank the engine based on the monitored increase of the working pressure.

An advantage of this aspect of the present invention is that damages and explosion of downstream low pressure elements due to malfunctioning regulators can be avoided. Thus, by adding the steps for controlling the permission to crank the engine of the present invention, the gas fuel system may be monitored before cranking of the engine is allowed. When cranking of the engine is disallowed, one or more valves in the system are kept shut, such that the high pressure gas is prevented from flowing from the high pressure circuit to the low pressure components in the low pressure circuit, i.e. is prevented from exploding or damaging downstream components, including e.g. injectors, filters and/or piping/hoses.

Thus, the function of the regulator is tested before allowing or disallowing cranking of the engine. If the regulator seems to be malfunctioning, cranking of the engine may be disallowed/prohibited, such that the risk for downstream component damages is minimized. Also, this testing may indicate if one or more of the components used for the above mentioned tests other than the regulator, such as e.g. pressure sensors and/or the pressure relief valve, are themselves broken or not working properly.

The present invention may for example be useful at maintenance, when the gas fuel system has been emptied. Emptying of the gas fuel system may cause the regulator to get stuck in its open position, which could cause bursting and/or other damages of the low pressure components. However, if the method according to the present invention is executed before starting the engine, the risk for such bursting and/or other damages is considerably reduced. Hereby, the risk for vehicle off road time, and hearing impairment and/or other injuries of a driver or technician is greatly reduced.

According to examples, controlling the permission to crank the engine may comprise, or consist of, disallowing or allowing cranking of the engine. In the context disclosed herein, cranking the engine means activating a rotation of the crank shaft, for example by usage of a starter motor. Thus, igniting is not comprised in the term cranking, and may be enabled or disabled during cranking. Typically, when starting the engine, the ignition system is enabled while cranking the engine such that the gas fuel in the cylinders is ignited by sparks. However, cranking of the engine may be performed with the ignition system being disabled, whereby the gas fuel is not ignited and the engine is not started.

According to an example, the pressure relief valve may be arranged on the downstream side of the at least one regulator. The pressure relief valve may be arranged on the downstream side of the at least one regulator, either as part of the regulator or separate from the regulator. According to an example, the pressure relief valve may be arranged upstream of the low pressure valve. The pressure relief valve may be arranged upstream of the low pressure valve and downstream the at least one upstream pressure sensor. The pressure relief valve may be arranged upstream of the low pressure valve and on the downstream side of the at least one regulator. This means that the low pressure valve may be arranged downstream of the at least one regulator and the pressure relief valve.

According to an embodiment of the present invention, if the monitored increase of the working pressure is above a first working pressure increase threshold value, the method comprises the step of:
closing the low pressure valve.

Hereby, the risk for bursting and/or other damages of low pressure components is considerably reduced, minimizing the risk for vehicle off road time, and hearing impairment and/or other injuries of a driver or technician.

According to an embodiment of the present invention, the method comprises the step of:
opening one or more injectors arranged to inject fuel into the engine.

This step may be performed after the step of closing the low pressure valve.

Hereby, the over-pressure in the gas fuel system is reduced, i.e. by shutting off the supply of gas fuel from the high pressure circuit, and by releasing gas fuel through the engine, i.e. through the air inlet manifold of the engine.

According to an embodiment of the present invention, the method further comprising one or more steps in the group of:
closing the one or more controllable valves;
activating a regulator fault code;
disabling an ignition system and initiating cranking of the engine; and
controlling the engine to work in a special mode, in which a gas volume in an air inlet of the engine and in cylinders of the engine is replaced by air while an ignition system is disabled.

By performing one or more of these actions, the gas fuel is safely ventilated and/or pumped out of the gas fuel system, without being ignited in the cylinders, such that the pressure in the gas fuel system is reduced. Also, a driver, a technician and/or another system may be made aware of that the regulator and/or other gas fuel system components are experiencing problems by activation of the regulator fault code, which may include fault codes also for other components.

These one or more actions may be performed after the step of opening one or more injectors arranged to inject fuel into the engine.

According to an embodiment of the present invention, if the monitored increase of the working pressure is above a first working pressure increase threshold value:
the controlling of the permission to crank the engine comprises disallowing cranking of the engine while an ignition system is enabled.

Hereby, the risk for bursting and/or other damages of low pressure components is considerably reduced.

According to an aspect of the present invention, if the monitored increase of the working pressure is below a second working pressure increase threshold value, the controlling of the permission to crank the engine comprises allowing cranking of the engine.

Thus, if the above mentioned pressure monitoring has indicated stabile pressures, and if the monitored increase of the working pressure is allowable, i.e. is below the second working pressure increase threshold value, then it is concluded that the regulator is functioning as it should. Cranking of the engine may then safely be allowed, without risk for downstream component damages.

According to an embodiment of the present invention, the gas fuel system comprises a pressure relief valve arranged to release fuel from the gas fuel system at a set pressure. The method further comprises, between the steps of controlling at least one of the one or more controllable valves such that the gas fuel system is pressurized upstream of the low pressure valve and opening the low pressure valve, the steps of:
closing the one or more controllable valves;
monitoring, by usage of the at least one upstream pressure sensor, a stability of the upstream pressure; and
controlling a permission to crank the engine based on the monitored stability.

In this document, a stability of a pressure is defined as a deviation of the pressure in relation to the level of the pressure. The pressure is monitored/detected/determined to be stabile if the deviation is less than a certain value during a predetermined time period, e.g. less than 1 bar during a time period in the range of 5 seconds to 1 minute, or less than 0.5 bar during a time period in the range of 5 seconds to 1 minute. The time period may for example be 10 seconds. Thus, the pressure is monitored/detected/determined to be stable if it does not decrease more than a certain value, for example 1 bar, during the time period, and to be unstable if the deviation is greater than that value during the time period.

An advantage of this embodiment is that damages and explosions of downstream low pressure elements due to malfunctioning regulators can be avoided by monitoring the stability of the upstream pressure. Hereby, the function of the regulator is tested before allowing or disallowing cranking of the engine. If the regulator seems to be malfunctioning, cranking of the engine may be disallowed/prohibited, such that the risk for downstream component damages is minimized.

According to an example, the at least one regulator may comprise multiple regulating stages. Thus, the at least one regulator may comprise a multi-stage regulator, such as a two-stage regulator, a tree-stage regulator etc. This means that the at least on regulator may regulate the upstream pressure down step-wise to the lower working pressure. This may be favourable in order to provide a more consistent and accurate working pressure of the fuel despite changes in upstream pressure into the at least one regulator. According to a specific example, the gas fuel system as disclosed herein may comprise at least one pressure relief valve and at least one regulator comprising multiple regulating stages, wherein the at least one pressure relief valve may be arranged on the downstream side of the respective regulating stage of the at least one regulator. The gas fuel system as disclosed herein may comprise multiple pressure relief valves and at least one regulator comprising multiple regulating stages, wherein each pressure relief valve may be arranged on the downstream side of each regulating stage of the at least one regulator. Thus, according to examples, the relief valve/s may be comprised in the at least one regulator.

According to an embodiment of the present invention, if the upstream pressure is stable, the method further comprises the following steps:
controlling the upstream pressure to be reduced to the set pressure of the pressure relief valve;
monitoring, by usage of the at least one upstream pressure sensor, a stability of the upstream pressure when reduced to the set pressure; and
controlling a permission to crank the engine based on the monitored stability.

Hereby, it is detected if the pressure relief valve is leaking and/or releasing gas fuel from the gas fuel system, i.e. if the regulator and/or pressure relief valve are broken or malfunctioning. If this is the case, cranking of the engine may be disallowed to avoid downstream component damages.

According to an embodiment of the present invention, if the upstream pressure is stable at the set pressure, the method further comprises the following steps:
controlling at least one of the one or more controllable valves to open, such that the gas fuel system downstream of the one or more controllable valves and upstream of the low pressure valve is filled with fuel;
monitoring, by usage of the at least one upstream pressure sensor, a stability of the upstream pressure after the filling; and
controlling a permission to crank the engine based on the monitored stability.

If the upstream pressure is stable, this may mean that the regulator has recovered, which may be concluded after further testing. However, if the upstream pressure is unstable here, it can be concluded that the regulator is malfunctioning, and cranking of the engine may be disallowed to avoid downstream component damages.

According to an embodiment of the present invention, if the monitoring indicates that the upstream pressure is unstable:
the control of the permission to crank the engine comprises disallowing cranking of the engine.

By disallowing cranking of the engine at unstable upstream pressures, the risk for downstream component explosion or other damages due to a malfunctioning regulator is considerably reduced.

According to an embodiment of the present invention, if the monitoring indicates that the upstream pressure is unstable, the method further comprises at least one step in the group of:
determining that a regulator failure is present; and
activating a regulator fault code.

The regulator failure and/or the regulator fault code mentioned above may relate to the at least one regulator arranged downstream of the one or more controllable valves to regulate the upstream pressure of the fuel down to a lower working pressure as disclosed herein.

By determining that a regulator failure is present and/or activating a fault code, the driver and/or technician, or any other systems, are alerted of the malfunctioning regulator. The risk for the driver, the technician and/or the other systems to cause dangerous situations is hereby considerably reduced.

According to an embodiment of the present invention, if the monitoring indicates that the upstream pressure is stable after the filling:
the controlling of the permission to crank the engine comprises the step of proceeding to the step of opening the low pressure.

Hereby, a thorough testing of the regulator is performed, in multiple steps, to secure that the regulator is working properly before cranking of the engine is allowed.

According to an aspect of the present invention, one or more of the monitored increase of the working pressure, and a first and a second working pressure increase threshold values comprise one in the group of:
an absolute value;
a derivative value; and
a value indicating change over time.

Depending on the features of the gas fuel system and/or on the current testing situation, suitable values for the increase of the working pressure and corresponding threshold values may be chosen to optimize the control of the permission to crank the engine.

According to an embodiment of the present invention, the method further comprises the step of, if one or more initial conditions are fulfilled in the group of:
the at least one working pressure sensor detects a working pressure below a first working pressure threshold value, and a vehicle comprising the gas fuel system is in standstill;
the at least one working pressure sensor detects a working pressure above a second working pressure threshold value, and a vehicle comprising the gas fuel system is in standstill; and
a fault code indicating that the working pressure has exceeded a third threshold value has been activated, and a fuel filling has been performed;
allowing the method to be performed.

Allowing the method to be performed may also be referred to as allowing the method to be executed, or started. To execute/start/perform the method for controlling the permission to crank the engine when one or more initial conditions are fulfilled limits the method to only be run when it is really necessary. It is thereby avoided that the driver has to wait for the method to be executed each and every time the engine is started, at the same time as the method is run when it is necessary for safety reasons.

According to an aspect of the present invention, the method is performed in connection with one in the group of:
maintenance;
a workshop visit; and
when the storage pressure is below a storage pressure threshold, and an engine fuel consumption is above a consumption threshold.

Hereby, the safety for the technicians and/or drivers at maintenance and/or in the workshop is greatly improved. Also, the risk for downstream component damages in connection with high engine load and/or gas fuel consumption when the tank levels are low is reduced. A high fuel consumption being above a consumption threshold may indicate that a choked flow in the regulator has occurred, which means that the regulator is completely open such that the regulator acts as an orifice where mass flow is effectively limited to an upper value and cannot further increase. The working pressure P3 decreases sharply when attempting to consume fuel beyond this upper level, i.e. when the flow is choked by the regulator. The consumption threshold associated with the choked flow may here be one of a number of consumption thresholds, each one being mapped to a certain storage pressure and an additional temperature. The fuel consumption is generally lower for lower storage pressures.

According to an aspect of the present invention, a processing arrangement configured to control a permission to crank an engine is presented. The engine is configured to be provided with a gas fuel by a gas fuel system.

The gas fuel system comprises:
one or more fuel tanks arranged to store the fuel at a storage pressure;
one or more controllable valves arranged downstream of the one or more fuel tanks, respectively, to provide the fuel to at least one regulator at an upstream pressure;
the at least one regulator arranged downstream of the one or more controllable valves to regulate the upstream pressure of the fuel down to a lower working pressure;
a low pressure valve arranged downstream of the at least one regulator;
one or more components arranged downstream of the low pressure valve to provide the fuel to the engine at the working pressure; and
at least one working pressure sensor arranged at the engine; the processing arrangement being configured to perform the following steps:
closing the low pressure valve;
controlling at least one of the one or more controllable valves such that the gas fuel system is pressurized upstream of the low pressure valve;
opening the low pressure valve;
monitoring, by use of the at least one working pressure sensor, an increase of the working pressure after the opening of the low pressure valve; and
controlling cranking of the engine based on the monitored increase of the working pressure.

It will be appreciated that all the embodiments described for the method aspects of the invention are applicable also the processing arrangement aspects of the invention. Thus, all the embodiments described for the method aspects of the invention may be performed by at least one processing arrangement, which may also be a control unit or a control device, i.e. a device. The processing arrangements and their embodiments have advantages corresponding to the advantages mentioned above for the methods and their embodiments.

According to an aspect of the present invention, a vehicle is presented. The vehicle comprising:
an engine;
a gas fuel system configured to provide fuel to the engine; and
a processing arrangement as herein described.

According to an aspect of the present invention, the above-mentioned computer program and computer-readable medium are configured to implement the method and its embodiments described herein.

### BRIEF LIST OF FIGURES

Embodiments of the invention will be illustrated in more detail below, along with the enclosed drawings, where similar references are used for similar parts, and where:

FIG. 1 schematically shows an example vehicle, in which embodiments of the present invention may be implemented,

FIG. 2 schematically shows a gas fuel system, in which embodiments of the present invention may be implemented,

FIG. 3 schematically shows an example regulator,

FIG. 4 schematically shows an example pressure relief valve,

FIG. 5 shows a flow chart for methods according to some aspects and/or embodiments of the present the invention,

FIG. 6 shows a flow chart for methods according to some aspects and/or embodiments of the present the invention,

FIG. 7 shows a control unit, in which a method according to any one of the herein described embodiments may be implemented.

### DESCRIPTION OF PREFERRED EMBODIMENTS

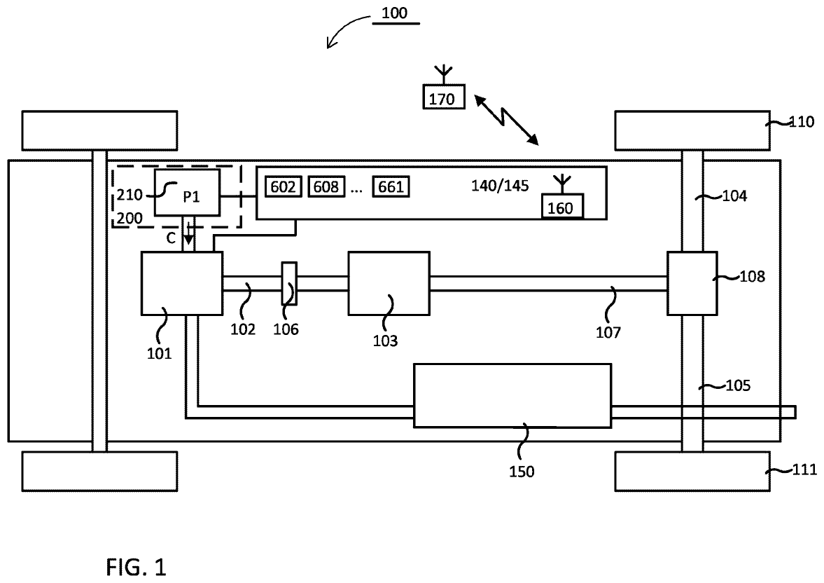

FIG. 1 schematically shows an example vehicle 100, such as a truck, a bus, a car, or another suitable vehicle, which will be used to explain the present invention. The present invention is, however, not limited to use in vehicles such as the one shown in FIG. 1, but may also be used in essentially any vehicle, such as e.g. railed vehicles or water vehicles. The present invention may further be used in stationary motors or working machines driven by gas fuel.

The vehicle 100, shown schematically in FIG. 1, comprises an engine 101, which may comprise a combustion engine, e.g. an engine consuming gas fuel, such as e.g. methane fuel or hydrogen gas fuel, in order to create a torque being provided for driving the vehicle. The engine may be an engine working according to the Otto cycle for which an electric spark, or a small amount of e.g. diesel, ignites a fuel and air mixture in the engine cylinders. Essentially, the engine 101 may in this document comprise any device which transforms chemical energy to mechanical energy, and uses gaseous state fuel for its combustion/energy transformation. The engine then provides energy in form of a torque to the powertrain, or electrical energy. Exhaust gases produced by the engine 101 may be purified by an exhaust treatment system 150. The vehicle 100 may also include one or more other engines and/or machines, e.g. electrical machines.

The engine 101 may, for example, in a customary fashion, via an output shaft 102 of the engine 101, be connected with a gearbox 103, via a clutch 106 and an input shaft connected to the gearbox 103. An output shaft 107 from the gearbox 103, also known as a propeller shaft, may drive the driving wheels 110, 111 via a final gear 108, such as e.g. a customary differential, and drive shafts 104, 105 connected with the final gear 108.

A gas fuel system 200, including at least one fuel tank 210 storing fuel at a storage pressure P1, is arranged for providing the engine 101 with fuel. The gas fuel providing system 200 is described more in detail below.

A control unit/system 140 is in FIG. 1 schematically illustrated as receiving signals and/or providing control signals from and/or to the engine 101 and/or the gas fuel system 200. The control unit/system 140 may also receive and/or provide control signals to and/or from other devices/components within the vehicle 100, or devices 170 external to the vehicle 101 via a communication unit 160. The control unit/system 140 may correspond to, or may include the herein described processing arrangement 145. The control unit/system/processing arrangement 140/145 may comprise the below mentioned control entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661, as indicate by 602, 604, . . . 661 in FIG. 1. The vehicle 100 may of course comprise a large number of devices/arrangements/units. In FIG. 1, however, only the units/devices/entities of the vehicle useful for understanding the present invention are illustrated.

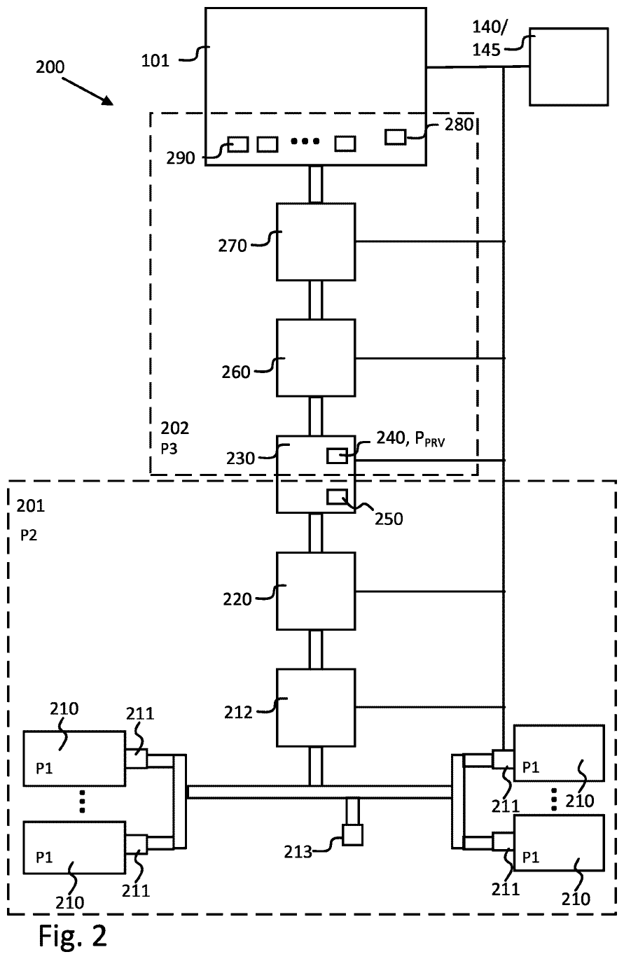

FIG. 2 schematically shows an example of a gas fuel system 200 configured to provide fuel to an engine 101, i.e. into the cylinders of the engine 101, which is going to be used for explaining the herein described aspects and embodiments. The gas fuel system 200 may comprise a high pressure circuit 201 and a low pressure circuit 202. It should be noted that although the border between the high 201 and low 202 pressure circuits is schematically illustrated as positioned in the regulator 230 in FIG. 2, the border may be adjusted to other positions in the gas fuel system 200.

Generally, the extensions of the high 201 and low 202 pressure circuits, respectively, may follow component pressure rating rather than the nominal pressure in the system 200. For example, if the below described regulator 230 is stuck open and the below described low pressure valve 260 is closed, the border between the between the high 201 and low 202 pressure circuits is moved to the low pressure valve 260.

The gas fuel system 200 comprises one or more fuel tanks 210 arranged to store the fuel at a storage pressure P1. The fuel tanks 210 may be filled via a tank filling arrangement 213. One or more controllable valves 211 are arranged downstream of the one or more fuel tanks 210, respectively, for example one valve 211 at each fuel tank 210, to provide the fuel to at least one downstream arranged regulator 230 at an upstream pressure P2, or to shut off the fuel supply from the fuel tanks 210 to the at least one regulator.

The one or more controllable valves 211 may be electronically actuated valves, that are typically controlled to be open during cranking of the engine 101, i.e. when a starter motor is cranking the engine 101. The gas fuel system 200 may comprise at least one manual valve 212, which may be easily accessible, e.g. for a technician during service/maintenance. Such an easily accessible manual valve is especially useful when the fuel tanks 210 and the controllable valves 211 are more difficult to access. For example, in some vehicles, such as buses, the fuel tanks 210 are mounted on the roof of the vehicle.

During service/maintenance, such as at workshop visits, when the gas fuel system 200 should be depressurized/emptied, the manual valve 212 and/or the controllable valves 211 are closed and the engine 101 is run until the engine stalls. Only small amounts of fuel are then left in the gas fuel system 200, i.e. in the piping/hoses and other components of the system. The gas fuel system 200 may also comprise an analog pressure sensor 220 close to the manual valve 212, which may indicate the pressure to a technician, e.g. in connection with opening or closing of the manual valve 212.

The gas fuel system 200 may further comprise at least one regulator 230 arranged downstream of the one or more controllable valves 211 and the possible analog pressure sensor 220 (if any) to regulate the upstream pressure P2 of the fuel down to a lower working pressure P3. Thus, the function of the at least one regulator 230 is to reduce the upstream pressure P2 down to the working pressure P3 of the one or more injectors 270. The at least one regulator 230 may here be arranged as one single regulator, or as two or more parallel regulators. The function of a regulator is explained in detail below.

The gas fuel system 200 further comprises a pressure relief valve 240 arranged to release fuel from the gas fuel system 200 at a set pressure P_{PRV}. The pressure relief valve 240 may be arranged as comprised in the at least one regulator 230, or may be arranged as a separate component downstream of the at least one regulator 230. The pressure relief valve 240 is explained in detail below.

The gas fuel system 200 further comprises at least one upstream pressure sensor 250, which may be arranged at the at least one regulator 230 or may be arranged separate from the at least one regulator 230, e.g. at a pipe/hose or at another component upstream of the regulator 230, to measure the upstream pressure P2 at the at least one regulator 230 or upstream of the regulator 230.

It should be noted that although the pressure relief valve 240 and the at least one upstream pressure sensor 250 are illustrated as comprised in the regulator 230 in FIG. 2, the pressure relief valve 240 and/or the at least one upstream pressure sensor 250 may, as mentioned above, be arranged separate from the regulator 230.

The gas fuel system 200 further comprises components arranged downstream of the at least one regulator 230 to provide the fuel to the engine 101 at the working pressure P3. These components may comprise e.g. one or more injectors 290 arranged at the engine 101 for injecting fuel into the cylinders of the engine 101. These components may also comprise one or more filters 270 arranged upstream of the one or more injectors 290 since the injectors 290 are very sensitive to dirt and oils. Alternatively, one or more high pressure filters may be arranged upstream of the at least one regulator 230, whereby one or more filters 270 downstream of the regulator may be omitted. The components downstream of the at least one regulator 230 are chosen/designed to align with the working pressure P3 of the injectors. In order to more easily detect leakages on the gas fuel system 200, an electronically controlled low pressure valve 260, also denoted low pressure shut-off valve, is arranged positioned downstream of the at least one regulator 230 and upstream of the components. The low pressure valve 260 allows for dividing the gas volume in the gas fuel system 200 into two parts when the low pressure valve 160 is closed. The downstream components may also comprise piping/hoses arranged for transfer of the gas fuel.

The gas fuel system 200 further comprises at least one working pressure sensor 280 arranged at the engine 101, or at least adjacent to the engine and/or injectors, for detecting a working pressure P3 at the engine 101. Thus, at least one pressure sensor 250, 280 is arranged in each part of the gas volume. These pressure sensors 250, 280 may monitor each part of the gas volume for sudden pressure drops, which may indicate a broken pipe or similar damages. Additionally, the pressure may, by usage of the pressure sensors 250, 280, be monitored during engine shut-off for slower pressure drops, possibly signifying/indicating that a small leakage may be present in the system 200.

The one or more controllable valves 211 and the low pressure valve 260 are initially controlled to be closed when the ignition is turned on, but are then controlled to be opened when the engine 101 is cranked, such that gas fuel is provided to the engine during cranking.

FIG. 2 also schematically illustrates a control unit/system/processing arrangement 140/145 configured for receiving signals and/or providing control signals from and/or to the engine 101 and/or one or more components 211, 212, 220, 230, 240, 250, 260, 270, 280, 290 of the gas fuel system 200. It should be noted that the control unit/system/processing arrangement 140/145 may be configured for receiving signals and/or providing control signals from each one of the one or more controllable valves 211, although not illustrated in FIG. 2 for readability reasons.

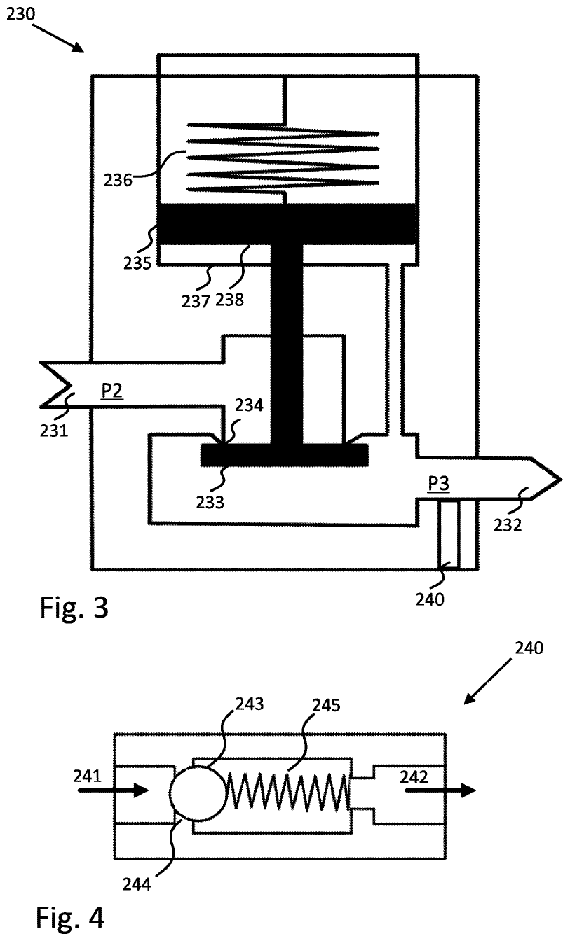

FIG. 3 schematically illustrates a cross section of a regulator 230 useful e.g. in the gas fuel system 200. It should be noted that FIG. 3 shows an example of a simple regulator, which is used for explaining the herein presented aspects and embodiments. As is understood by a skilled person, the herein described solutions may be implemented in systems comprising more complex regulators. As mentioned above, the regulator 230 is arranged to regulate the upstream pressure P2 of the fuel at the inlet 231 of the regulator down to a lower working pressure P3 at the outlet 232 of the regulator. Thus, the function of the regulator 230 is to reduce the upstream pressure P2 down to the downstream working pressure P3.

Regulators 230 are commonly used components in gaseous systems, where a higher feed pressure is regulated down to a lower pressure. The lower pressure downstream of the regulator 230 might be required due to a functional need of the downstream components for a lower specific gas pressure. Also, a regulator 230 may be used for regulating a fluctuating higher feed pressure and into a stable lower gas pressure. Regulators may utilize a principle of a regulator spring arrangement 236 being counteracted by the lower gas pressure P3 acting on a surface 238. Regulators may also be actuated in one or more steps with intermediate pressures and/or by electronic regulation utilizing of magnetic spools to control the below described opening orifice. Also, some regulators may comprise multiple regulating stages, such as e.g. a mechanical stage followed by an electronic stage. An electronic regulating stage may then additionally take the function of a low pressure valve. Thus, according to an example, the low pressure valve 260 may comprise, or consist of, an electronic regulating stage comprised in the at least one regulator 230.

Gas regulators are used in gas fuel systems, such as methane gas fuel systems or hydrogen gas fuel systems. In compressed natural gas fuel systems, for example, the fuel is commonly stored in its fuel tanks at a storage pressure P1 in the range of 20 to 200 bar, and in some systems up to 250 bar. This high pressure itself is then used for feeding the fuel to the engine 101. The regulator 230 is in gas fuel systems used to transfer the high upstream pressure P2, resulting from the high storage pressure P1, to a working pressure P3, which the injectors are designed for, commonly in the range of 6 to 9 bar. In liquified natural gas fuel systems, for example, the gas is stored in its fuel tanks at a storage pressure P1 in the range of 8 to 16 bar. Due to the different pressures and volumetric flows, the designs of the regulators are different for compressed natural gas fuel systems and liquified natural gas fuel systems.

When no flow occurs through the regulator 230, and the counteracting forces of the regulator spring arrangement 236 and the lower working pressure P3 acting against the surface 238 perfectly match each other, the regulator poppet 233 closes against its seat 234, i.e. the opening orifice between the regulator poppet 233 and its seat 234 is closed. When the downstream lower working pressure P3 is reduced from this balanced state, the regulator spring arrangement 236 will exert more force than the counteracting force of the working pressure P3 against the surface 238. The poppet 233 is therefore moved away from its seat 234, such that the poppet 233 is moved to an open position. In this open position of the poppet 233, filling/refilling of the downstream gas volume takes place, and the downstream working pressure P3 is increased again. Thus, the regulator 230 is always seeking to maintain in balance. If a flow through the regulator occurs, the poppet 233 will move to a position where the balance is achieved again. The surface 238, against which the downstream working pressure P3 acts, may be comprised in a regulator actuator 235 in the form of a diaphragm or piston, as schematically shown in FIG. 3. In some cases, the upstream pressure P2 and/or the working pressure P3 further act on the poppet to open and close, respectively, the opening orifice between the regulator poppet 233 and its seat 234. Also, an engine air inlet pressure may be fed back to the volume of the regulator spring arrangement 236, thereby acting to open the opening orifice.

When the upstream pressure P2 is reduced, the density of the upstream gas volume is also reduced, which in turn means that the volumetric flow past the poppet 233 will be increased for a given fuel need, i.e. for a needed weight/amount of fuel, e.g. in kilograms, per time unit. Since the regulator 230 strives to achieve balance, the poppet 233 is then forced to open up even more, thereby allowing an even greater volumetric flow. At a certain low level for the upstream pressure P2, and therefore also for the working pressure P3, the regulator actuator 235 cannot physically open the poppet 233 more, as it comes to its end of motion, i.e. it hits the end wall 237 of the space/cylinder in which it moves. Thus, at least a part of the surface 238 of the regulator actuator 235 is pushed against the end wall 237. This may e.g. occur when the gas fuel system 200 is emptied, since the working pressure P3 is then far too low to able to counteract the force of the regulator spring arrangement 236.

The poppet 233 and seat 234 are in principle only in contact when there is no flow though the regulator 230. Thus, wear of the poppet 233 mostly occurs during this non-flow time. However, wear may also occur due to particulates in the gas stream downstream of the poppet 233. If the poppet 233 and seat 234 cannot achieve a tight seal to prohibit flow, then the downstream working pressure P3 will continue to rise. The rise of the working pressure P3 will cause the regulator actuator 235 to move upwards and push the poppet 233 into the seat 234 with an even higher force, which may cause shape deformations of the poppet 233. For example, such deformation may be in form of a ring recess on the surface of the poppet 233, where the ring recess becomes deeper and deeper as the wear proceeds. At some point, the seal will be achieved, and the flow will be interrupted, unless the regulator seat 234 is too deformed or worn out.

To handle the situation where the regulator seat 234 is too worn out to achieve a tight seal together with the poppet 233, the gas fuel system 200 may comprise a pressure relief valve (PRV) 240 arranged on the downstream side i.e. at the working pressure P3 side, either as part of the regulator 230 or separate from the regulator 230. In FIG. 3, the pressure relief valve 240 is illustrated as part of the regulator 230 for simplicity. The pressure relief valve 240 is arranged to release fuel from the gas fuel system 200 at a set pressure P_{PRV} to relieve over-pressure, where the set pressure P_{PRV} commonly is slightly higher, for example in the range of 10 to 12 bar, than the design pressure of the downstream components, such as e.g. the injectors 290.

FIG. 4 schematically illustrates a cross section of an example of a pressure relief valve 240, which in its simplest form works according to the principle of a pressure relief valve spring arrangement 245 which closes a valve at lower working pressures P3. At a certain working pressure P3 value, the pressure relief valve spring arrangement 245 is over-powered by the force exerted to a pressure relief valve actuator 243 by the gas, such that the actuator 243 moves away from its seat 244, thereby allowing gas to flow from the pressure relief valve inlet 241, through the pressure relief valve 240, and out from the pressure relief valve outlet 242. The outlet pressure relief valve outlet 242 may be in connection with ambient pressure conditions. Hereby, pressure release of gas at the working pressure P3 from the gas fuel system 200 is achieved.

In the gas fuel system 200, debris and oils may be introduced in the fuel system by filling/fuelling operations. Additionally, grease may be introduced during manufacturing of the components of the gas fuel system. The amount of oil present in the fuel depends to a large extent on the maintenance of the fuelling stations. Generally, maintenance of the compressors and filters of fuelling stations is important to ensure smooth operations of gas vehicle. Oil is used to ensure smooth operation of the compressors at the fuelling stations, but as the compressors are worn out, they will consume more and more oil. The oil from the fuelling stations needs to be filtered out from the fuel in several filtering steps after passing the compressor. Also, as the gas expands in the regulator, through the area of the poppet 233 and seat 234, the temperature of the gas drops, as explained by the Joule-Thomson effect. This temperature drop causes oils present in the gas to precipitate and to stick onto the inner surfaces of the regulator, for example onto the end wall 237 and the actuator surface 238 that will come in contact with each other.

If the surfaces between the regulator body and regulator actuator 235, e.g. the end wall 237 and the actuator surface 238, are coated with oil or grease when the surfaces are joined, they will be, depending on their geometry, difficult to pull apart by the working pressure P3 acting on the actuator surface 238, resulting in a stuck-open poppet 233. This is because of a vacuum, contained by a capillary bridge of the oil or grease, occurring between the surfaces 237, 238 when attempting to separate them. It is well known how a coaster, i.e. a small plate, may stick on to a bottom of a glass if there is moisture between them. A similar vacuum effect here occurs between the surfaces 237, 238 of the regulator body and the regulator actuator 235 if there is oil or grease between them. This problem may for example occur during workshop visits, when the gas fuel system 200 is emptied downstream of the controllable valves 211 during maintenance.

The problem may also occur when running the engine 101 at high engine fuel consumptions, e.g. at an engine fuel consumption C is above a consumption threshold Cₜₕ; C>Cₜₕ; when the fuel tanks are almost empty, e.g. when the storage pressure P1 is below a storage pressure threshold P1ₜₕ; P1<P1ₜₕ. Each consumption threshold Cₜₕ may here be related to a storage pressure threshold P1ₜₕ, where the storage pressure threshold P1ₜₕ may have a value associated with how well the regulator matches the engine, and may for example have a value in the range of 10-20 bar, related to when the regulator is wide open such that choked flow starts to occur.

When this fault occurs, i.e. when the poppet 233 is stuck in its open position, the regulator 230 ceases to regulate the pressure and is instead completely open. This can lead to a sharp rise in the working pressure P3 downstream of the regulator 230, which may possibly approach the storage pressure P1, possibly up to 200 bar at fully filled tanks. The pressure relief valve 240 is not designed to cope with such high pressures and flows, and can then not release the gas sufficiently quick so that the downstream pressure is kept at safe levels. The electrically controlled low pressure/shut-off valve 260 is designed to cope with such high pressures if necessary, and therefore has a burst pressure in line with the high pressure circuit system components. If the low pressure/shut-off valve 260 is open however, for example because the engine 101 is being cranked, then the downstream arranged fuel filter 270 and/or downstream fuel piping/hoses may burst because of the high pressure. Such component bursting due to high pressures may cause vehicle off road time, as well as hearing impairment and/or other injuries of a driver of the vehicle 100.

The aspects and embodiments of the present invention at least partly solve these problems.

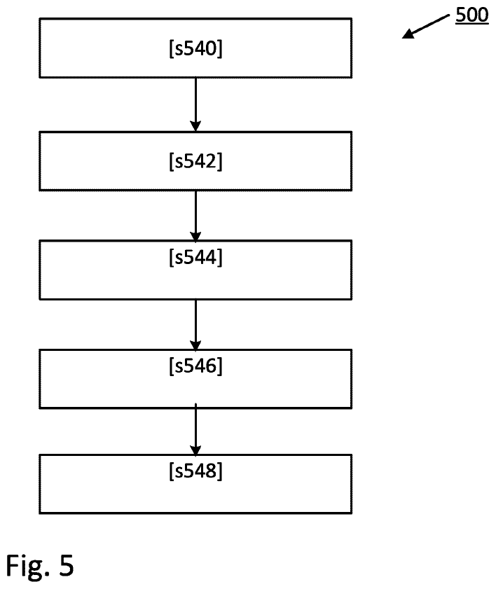

FIG. 5 shows a flow chart for a method 500 for controlling a permission to crank an engine. The engine 101 is provided with gas fuel by a gas fuel system 200, which comprises one or more fuel tanks 210 configured to store the fuel at a storage pressure P1, and one or more controllable valves 211 arranged downstream of the one or more fuel tanks 210, respectively, to provide the fuel to at least one regulator 230 at an upstream pressure P2. The gas fuel system 200 further comprises at least one regulator 230 arranged downstream of the one or more controllable valves 211 to regulate the upstream pressure P2 of the fuel down to a lower working pressure P3. Downstream of the regulator, a low pressure valve 260 is arranged upstream of one or more components 270, 290 arranged to provide the fuel to the engine 101 at the working pressure. At least one working pressure sensor 280 is arranged at the engine, i.e. adjacent to the one or more injectors 290, to measure the working pressure P3.

It should be noted that the method steps illustrated in FIG. 5 and described herein do not necessarily have to be executed in the order illustrated in FIG. 5. The steps may essentially be executed in any suitable order, as long as the physical requirements and the information needed to execute each step is available when the step is executed.

Generally, as mentioned above, the method may most likely be performed in connection with maintenance, for example during a workshop visit. The method may possibly also be performed due to during running the engine 101 at high engine fuel consumptions when the fuel tanks are almost empty.

In a step s540 of the method, the low pressure valve 260 is closed.

In a step s542 of the method, at least one of the one or more controllable valves 211 is controlled such that the gas fuel system 200 is pressurized upstream of the low pressure valve 260. For example, the at least one controllable valve 211 may be controlled to open such that the upstream pressure P2 corresponds to the storage pressure P1. Then, the at least one controllable valve 211 is closed again. The gas fuel system being pressurized in this document means that the upstream pressure P2 is above an upstream threshold value P2ₜₕ; P2>P2ₜₕ. The upstream threshold value P2ₜₕ may e.g. be associated with an upstream pressure P2 value stored when the engine was previously stopped, which may indicate that the testing of the gas fuel system should be performed. The upstream threshold value P2ₜₕ may also be associated with filling of the fuel tanks, possibly causing an upstream pressure P2 high enough to cause damages to downstream components.

For example, if the engine 101 has been running with almost empty fuel tanks 210, whereafter the fuel tanks 210 are filled with fuel, then the upstream threshold value P2ₜₕ may be set to correspond to the upstream pressure P2 detected before filling of the fuel tanks 210. If the upstream pressure P2 detected before filling was low, e.g. 10 bar, without experiencing any running problems of the engine, then it may be the case that the regulator was then completely open. Therefore, if the upstream pressure P2 detected after the fuel filling is higher than the upstream threshold value P2ₜₕ, it may be preferrable to run the test to make sure that the regulator 230 is not stuck in its open position.

In a step s544 of the method, the low pressure valve 260 is opened. The gas fuel previously having been pressurized and closed off upstream of the closed low pressure valve 260 is hereby released to the rest of the gas fuel system downstream of the low pressure valve 260. Thus, the gas fuel system downstream of the low pressure valve 260 is now filled with gas fuel such that the working pressure P3 increases.

In a step s546 of the method, an increase of the working pressure ΔP3 after the opening s544 of the low pressure valve 260 is monitored by usage of the at least one working pressure sensor 280. Thus, the at least one working pressure sensor 280 measures the working pressure P3, and the increase of the working pressure ΔP3 is analyzed, as herein described.

In a step s548 of the method, a permission to crank the engine 101 is controlled based on the monitored/detected increase of the working pressure ΔP3, as described in detail below.

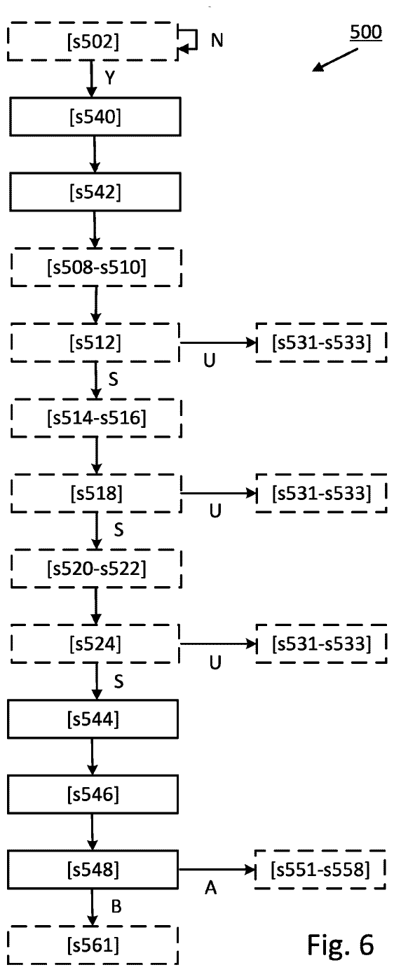

FIG. 6 shows a flow chart diagram for various embodiments of the present invention.

It should be noted that the method steps illustrated in FIG. 6 and described herein do not necessarily have to be executed in the order illustrated in FIG. 6. The steps may essentially be executed in any suitable order, as long as the physical requirements and the information needed to execute each step is available when the step is executed. Also, as a number of embodiments are illustrated in FIG. 6, it should be noted that not all steps illustrated in FIG. 6 have to be performed for each embodiment. Thus, only the steps associated with a specific embodiment have to be performed/executed when that embodiment is utilized.

In step s502 in FIG. 6, it is, according to an embodiment, detected if one or more of initial conditions are fulfilled, as described below. If at least one of the initial conditions is fulfilled (Y), the method 500 is allowed to be performed. According to an embodiment, and the method then proceeds to step s540, as illustrated in FIG. 6. If none of the initial conditions is fulfilled (N), then step s502 is repeated.

One such initial condition is that the at least one working pressure sensor 280 detects a working pressure P3 being lower than a first working pressure threshold value P3ₜₕ₁; P3<P3ₜₕ₁; and that it is also detected, e.g. by usage of a speedometer, an accelerometer or another device providing a suitable movement input, that the vehicle 100 comprising the gas fuel system 200 is in standstill. The first working pressure threshold value P3ₜₕ₁ may here have a relatively low value, e.g. in the range of 4-5 bar.

Another such initial condition is that the at least one working pressure sensor 280 detects a working pressure P3 being higher than a second working pressure threshold value P3ₜₕ₂; P3>P3ₜₕ₂; and that is also detected, based on a suitable input, that the vehicle 100 is in standstill. The second working pressure threshold value P3ₜₕ₂ may here have a relatively high value, e.g. at least 10 bar.

Another such initial condition is that a fault code has been activated because the at least one working pressure sensor 280 has measured a working pressure P3 exceeding a third threshold value P3ₜₕ₃; P3>P3ₜₕ₃, and that a fuel filling has been detected based e.g. on information associated with a fuel tank level. The third working pressure threshold value P3ₜₕ₃ may here have a value of e.g. at least 16 bar.

It should be noted that if the gas fuel system 200 is not pressurized when the at least one controllable valve 211 is controlled to be slowly opened in step s542, i.e. if the upstream pressure sensor 250 does not detect an upstream pressure P2 above the above mentioned upstream pressure threshold P2ₜₕ, this may be caused e.g. by a technician trying to empty the gas fuel system from of gas and/or by the manual valve 212 being closed. In this case, the method could possibly include an additional step of activating a fault code in order to indicate that this fault(s) needs to be fixed before proceeding with the method.

According to an embodiment, if one or more initial conditions are fulfilled, (Y) the method proceeds to step s540.

In a step S540 of the method, the low pressure valve 260 is closed.

In a step s542 of the method, at least one of the one or more controllable valves 211 is controlled such that the gas fuel system 200 is pressurized upstream of the low pressure valve 260. For example, the at least one controllable valve 211 may be controlled to open such that the upstream pressure P2 corresponds to the storage pressure P3. Then, the at least one controllable valve 211 is closed again. The gas fuel system being pressurized in this document means that the upstream pressure P2 is above an upstream threshold value P2ₜₕ; P2>P2ₜₕ. The upstream threshold value P2ₜₕ may e.g. be associated with an upstream pressure P2 value stored when the engine was previously stopped, which may indicate that the testing of the gas fuel systems should be performed. The upstream threshold value P2ₜₕ may also be associated with filling of the fuel tanks, possibly causing an upstream pressure P2 high enough to cause damages to downstream components.

In a step s508 of the method, the one or more controllable valves 211 are closed. Thus, the gas fuel system is now pressurized between the closed one or more controllable valves 211 and the closed low pressure valve 260. This also means that the gas fuel volume is restricted/closed off by the closed the closed one or more controllable valves 211 and the closed low pressure valve 260, such that fuel is present in the gas fuel system 200 from the upstream one or more fuel tanks 210 and to the downstream closed low pressure valve 260.

In a step s510 of the method, a stability of the upstream pressure P2 is monitored/determined by usage of the at least one upstream pressure sensor 250. Thus, the at least one upstream pressure sensor 250 measures the upstream pressure P2, and the deviation/fluctuation of the upstream pressure P2 is analyzed, as herein described. For example, if the deviation is less than a certain value, e.g. if it does not decrease more than 1 bar, the pressure P2 is determined as stable. Conversely, it is then determined as unstable if the deviation is greater than that value, which may mean that there is a leakage somewhere in the system.

In a step s512 of the method, a permission to crank the engine 101 is controlled based on the monitored/detected stability.

If the monitoring of the upstream pressure P2 in step s510 indicates that the upstream pressure P2 is unstable (U), the method proceeds, according to an embodiment, from step s512 to one or more of steps s531-s533. In step s531, cranking of the engine 101 is disallowed, such that bursting and/or damages of the downstream components is prevented. In step s532, it is determined that a regulator failure is present, and in step s533, a regulator fault code is activated, such that the failing regulator 230 is indicated.

If the upstream pressure P2 is monitored/detected as being stable(S), the method instead proceeds, according to an embodiment, from step s512 to steps s514-s516, in order to further analyze if the regulator 230 and the pressure relief valve 240 are working properly.

In step s514, the upstream pressure P2 is controlled to be reduced to the set pressure P_{PRV} of the pressure relief valve 240. For example, the upstream pressure P2 may be allowed to passively decrease to the set pressure P_{PRV} by closing the one or more controllable valves 211.

In step s516, a stability of the upstream pressure P2 is monitored when it is reduced to the set pressure P_{PRV}. The at least one upstream pressure sensor 250 is here used for detecting the upstream pressure P2 and its stability. If the upstream pressure P2 deviates less than a certain value, for example 1 bar, during a time period from the set pressure P_{PRV}, it is here considered to be stable. However, if the upstream pressure P2 deviates more than this certain value from the set pressure P_{PRV}, it is considered to be unstable.

It should be noted that an unstable upstream pressure P2 may be caused by the pressure relief valve 240 opening and releasing gas fuel, due to a faulty regulator. On the other hand, if the pressure relief valve 240 remains closed, this indicates that the regulator 230 is working. Then the gas fuel is merely trapped in an enclosed volume, resulting in a stable upstream pressure P2.

In step s518, a permission to crank the engine 101 is controlled based on the stability detected in step s516. If the monitoring in step s516 indicates that the upstream pressure P2 is unstable (U), this may indicate a failing regulator 230, and the method proceeds, according to an embodiment, from step s518 to one or more of steps s531-s533 described above, such that bursting and/or damages of the downstream components is prevented. If the monitoring of the upstream pressure P2 indicates that the upstream pressure P2 is stable(S) in step s516, the method proceeds, according to an embodiment, from step s518 to step s520.

In step s520, at least one of the one or more controllable valves 211 is controlled to be open, such that the gas fuel system 200 downstream of the one or more controllable valves 211 and upstream of the low pressure valve 260 is filled with fuel, i.e. is pressurized again.

In step s522, a stability of the upstream pressure P2 after the filling in step s520 is monitored. The at least one upstream pressure sensor 250 is here used for monitoring the upstream pressure P2 and its stability.

In step s524, a permission to crank the engine 101 is controlled based on the monitored stability of the upstream pressure P2 in step s522. If the monitoring of the upstream pressure P2 indicates that the upstream pressure P2 is unstable (U) in step s522, this means that the regulator 230 is not working properly, and the method proceeds, according to an embodiment, from step s524 to one or more of steps s531-s533 described above, such that bursting and/or damages of the downstream components is prevented. If the monitoring of the upstream pressure P2 indicates that the upstream pressure P2 is stable(S) in step s522, this may indicate that the regulator 230 has recovered, and the method proceeds, according to an embodiment, from step s524 to step s540.

For example, if the gas fuel system 200 downstream of the one or more controllable valves 211 and upstream of the low pressure valve 260 is here pressurized to a suitable value, e.g. 13 bar, then the upstream pressure P2 is considered to be stable if it deviates less than a certain value, for example 1 bar, from this suitable value during a time period. Conversely, if the upstream pressure P2 deviates more than this certain value from the suitable value, it is considered to be unstable.

Steps s540-s548 are described above in connection with FIG. 5. In these steps an increase of the working pressure ΔP3 after the opening s544 of the low pressure valve 260 is monitored by usage of the at least one working pressure sensor 280.

If the monitored s546 increase of the working pressure ΔP3 is higher than allowed, i.e. is above (A) a first working pressure increase threshold value ΔP3ₜₕ₁; ΔP3>ΔP3ₜₕ₁, then the method proceeds, according to an embodiment, to step s551, in which cranking of the engine 101 while an ignition system is enabled is disallowed.

According to an embodiment, if the increase of the working pressure ΔP3 is above (A) the first working pressure increase threshold value ΔP3ₜₕ₁; ΔP3>ΔP3ₜₕ₁, the method proceeds to step s552. In step s552, the low pressure valve 260 is closed, which prevents or limits further increase of the working pressure P3, i.e. mitigates further pressure increase in the low pressure circuit 202. The method then proceeds to step s553, in which one or more injectors 290 arranged to inject fuel into the engine 101 are opened, such that the gas fuel flows through the one or more injectors 290 and thereby reduces the working pressure P3. According to various embodiments, the method may then proceed to perform one or more of steps s554-s558.

Thus, according to some embodiments, the one or more injectors 290 will inject fuel into the air inlet manifold (plenum) of the engine 101, and if any cylinders of the engine are in an air intake stroke, then those cylinders will also be filled with gas.

Some engines may have both inlet and outlet valves open at the same time, such that the gas fuel flows through the cylinders. In this case, the exhaust treatment system may be filled with gas fuel as well. This is still a preferential behaviour, compared to downstream components bursting or being damaged in the gas fuel system 200.

As mentioned below, the increase of the working pressure ΔP3 and the first working pressure increase threshold ΔP3ₜₕ₁ value may comprise an absolute value, a derivative value, and/or a value indicating change over time, respectively. It should be noted that the working pressure P3 normally is very low, e.g. zero bar, initially, due to the fact that the fuel system downstream of the low pressure valve 260 is empty when the test is run, i.e. before the low pressure valve 260 is opened in step s541. Therefore, an absolute value for an increase of the working pressure ΔP3 may also correspond to an absolute value for the working pressure P3. Correspondingly, an absolute value for the first working pressure increase threshold ΔP3ₜₕ₁ may correspond to an absolute threshold value for the working pressure P3.

The first working pressure increase threshold value ΔP3ₜₕ₁ may have a value such that the one or more injectors 290 are opened quickly enough to mitigate a dangerous working pressure increase, for example 10 bar for the case that the increase of the working pressure ΔP3 is an absolute value.

If the increase of the working pressure ΔP3 indicates some kind of pressure change over time, e.g. a derivative value, then the first working pressure increase threshold ΔP3ₜₕ₁ value is a corresponding change over time threshold value. For example, the first working pressure increase threshold ΔP3ₜₕ₁ may be related to a closing time of the low pressure valve 260, which may e.g. be in the range of 60-100 ms, such that a dangerous pressure increase during this closing time may be avoided. Generally, a too high working pressure ΔP3, e.g. above 13 bar, which may block opening of the one or more injectors 290, should be avoided. This may be achieved by setting the first working pressure increase threshold ΔP3ₜₕ₁ to a suitable value for an absolute change, a derivative and/or a change over time. By analyzing the derivatives or other changes over time, and setting corresponding thresholds therefore, such too high working pressures P3 may be mitigated before they happen. Thus, if the pressure derivative or other change over time is fast/steep/high, then this gives an early indication of that a dangerous situation may occur later. The low pressure valve 260 may then be closed in time to avoid the dangerous situation.

In some situations, in which it is impossible to avoid too high working pressure ΔP3, the first working pressure increase threshold ΔP3ₜₕ₁ value may be chosen such that the working pressure ΔP3 value stays within a measuring range of the working pressure sensor 280, e.g. stays below 16 bar, such that a detectable working pressure P3 is at least achieved. The too high working pressure ΔP3 may then be reduced by opening one or more couplings in the gas fuel system 200, thereby releasing gas from the system.

In step s554, the one or more controllable valves 211 are closed, such that no further gas fuel is provided from the one or more fuel tanks 210.

In step s555, a regulator fault code is activated, such that the failing regulator 230 is indicated to a driver and/or technician.

In step s556, an ignition system is disabled, e.g. by disabling ignition sparks and/or disabling pre-injections of fuel used for igniting the gas fuel. Also, after the ignition system has been disabled, cranking of the engine 101 is initiated in step s557. By cranking the engine 101 when the ignition system is disabled, the gas fuel is pumped through the engine without being ignited. Hereby, the working pressure P3 is reduced, and the risk for bursting and damages of the downstream components 270, 290 is reduced.

In step s558, the engine 101 is controlled to work in a special mode. In this special mode, a gas volume present in an air inlet of the engine and in cylinders of the engine 101 is replaced by air while the ignition system is disabled. Hereby, the risk for bursting and damages of the downstream components 270, 290 is reduced.

Thus, when the one or more injectors 290 have been open, the engine 101 may be difficult to start, and combustible gas will be present in the air inlet manifold of the engine 101, and possibly also in the exhaust treatment system. If the engine is started in this mode, then parts of the exhaust treatment system could be damaged. The engine 101 should therefore, according to some embodiments, in this case be controlled to work in the special mode, in which the gas volume in the air inlet of the engine and in the cylinders is pushed out and is replaced with air, without firing the spark plugs. This is achieved by cranking the engine without opening any of the fuel systems valves, thereby pushing and/or consuming the gas mixture in the air inlet manifold and cylinder(s). Thus, the gas mixture is hereby pushed through the engine and exhaust treatment system, without damaging the downstream components, the engine or the exhaust treatment system.

According to an embodiment, if the increase of the working pressure ΔP3 monitored in step s546 has an allowable level, i.e. is below (B) a second working pressure increase threshold value ΔP3ₜₕ₂; ΔP3<ΔP3ₜₕ₂; the regulator 230 is determined to work properly, and the method proceeds to step s561, in which cranking of the engine 101 is allowed. Thus, the starter motor may then be activated.

As mentioned below, the increase of the working pressure ΔP3 and the second working pressure increase threshold ΔP3ₜₕ₂ value may comprise an absolute value, a derivative value, and/or a value indicating change over time, respectively.

The second working pressure increase threshold value ΔP3ₜₕ₂ may have a value such a safe determination of a properly working regulator 230 is achievable, for example 9 bar for the case that the increase of the working pressure ΔP3 is an absolute value.

According to various embodiments, the increase of the working pressure ΔP3 monitored in step s546 and/or the first ΔP3ₜₕ₁ and second ΔP3ₜₕ₂ working pressure increase threshold values may comprise an absolute value, a derivative value, i.e. a pressure change per time unit, and/or
a value indicating change over time, respectively. Essentially, any type of value/measurement indicating an increasing pressure, possibly in relation to a time interval, may be detected and evaluated.

According to an aspect of the invention, schematically illustrated in FIGS. 1, 2 and 7, a processing arrangement 145 of an engine control system 140 is presented. The processing arrangement 145 is configured to control a permission to crank an engine 101, where the engine 101 is configured to be provided with a gas fuel by the above described gas fuel system 200. The processing arrangement 145 is configured to perform the steps of the method, i.e. perform the steps of:
closing s540 the low pressure valve 260;
controlling s542 at least one of the one or more controllable valves 211 such that the gas fuel system 200 is pressurized upstream of the low pressure valve 260;
opening s544 the low pressure valve 260;
monitoring s546, by use of the at least one working pressure sensor 280, an increase of the working pressure ΔP3 after the opening s544 of the low pressure valve 260; and
controlling s548 cranking of the engine 101 based on the monitored increase of the working pressure ΔP3.

The processing arrangement 145, being a control unit, a control device or a device, is further configured to be able to perform the method steps of the herein described embodiments. Thus, the processing arrangement 145 is configured such that it may perform these herein described method steps, i.e. method steps s502, s508, s510, s512, s514, s516, s518, s520, s522, s524, s531, s532, s533, s540, s542, s544, s546, s548, s551, s532, s533, s551, s552, s553, s554, s555, s556, s557, s558 and s561. These method steps may be performed/executed by corresponding control entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661. The processing arrangement 145 is hereby provided with the above described advantages for each respective embodiment.

The person skilled in the art will appreciate that a the herein described embodiments for braking a vehicle may also be implemented in a computer program, which, when it is executed in a computer, instructs the computer to execute the method. The computer program is usually constituted by a computer program product 703 stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc.

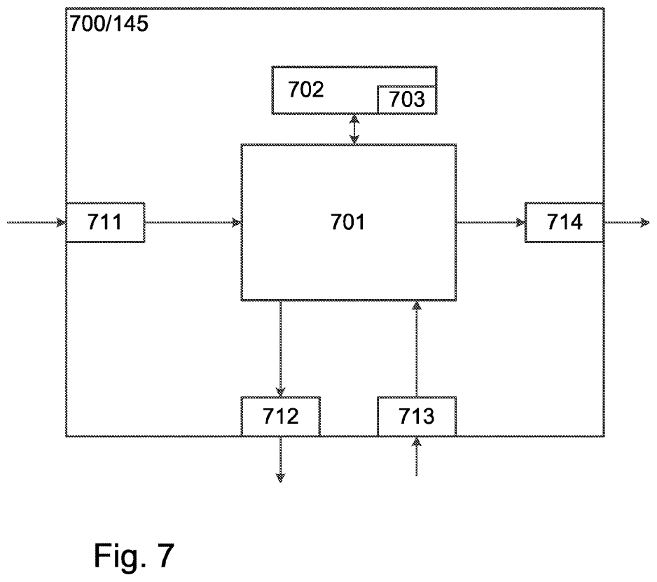

FIG. 7 shows in schematic representation a processing arrangement/control unit 700/145, which may include one or more of the above-mentioned control entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661. The control unit 700/145 comprises a computing unit 701, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 701 is connected to a memory unit 702 arranged in the control unit 700/145, which memory unit provides the computing unit 701 with, for example, the stored program code and/or the stored data which the computing unit 701 requires to be able to perform computations. The computing unit 701 is also arranged to store partial or final results of computations in the memory unit 702.

In addition, the control unit 700/145 is provided with devices 711, 712, 713, 714 for receiving and transmitting input and output signals. These input and output signals can contain waveforms, impulses, or other attributes which, by the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, for example, modulating the signals, which can be transmitted to other parts of and/or systems in the vehicle.

Each of the connections to the devices for receiving and transmitting input and output signals can be constituted by one or more of a cable; a data bus, such as a CAN bus (Controller Area Network bus), a MOST bus (Media Orientated Systems Transport bus), or some other bus configuration; or by a wireless connection. A person skilled in the art will appreciate that the above-stated computer can be constituted by the computing unit 701 and that the above-stated memory can be constituted by the memory unit 702.

Control systems in modern vehicles commonly comprise communication bus systems consisting of one or more communication buses for linking a number of electronic control units (ECU's), or controllers, and various components located on the vehicle. Such a control system can comprise a large number of control units and the responsibility for a specific function can be divided amongst more than one control unit. Vehicles of the shown type thus often comprise significantly more control units than are shown in FIGS. 1, 2 and 7, which is well known to the person skilled in the art within this technical field.

In a shown embodiment, the present invention may be implemented by one or more of the above mentioned control entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661 of the processing arrangement/control unit 700/145. The invention can also, however, be implemented wholly or partially in one or more other control units already present in the vehicle, or in some control unit dedicated to the present invention.

Here and in this document, units are often described as being arranged for performing steps of the method according to the invention. This also includes that the units are designed to and/or configured to perform these method steps.

The one or more control entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661 are in FIG. 1 illustrated as separate units/entities. These 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661 may, however, be logically separated but physically implemented in the same unit, or can be both logically and physically arranged together. These entities 602, 608, 610, 612, 614, 616, 618, 620, 622, 624, 631, 632, 633, 640, 642, 644, 646, 648, 651, 632, 633, 651, 652, 653, 654, 655, 656, 657, 658 and 661 may for example correspond to groups of instructions, which can be in the form of programming code, that are input into, and are utilized by a processor/computing unit 701 when the units are active and/or are utilized for performing its method step, respectively.

The present invention is not limited to the above described embodiments. Instead, the present invention relates to, and encompasses all different embodiments being included within the scope of the independent claims.

2. The method as claimed in claim 1, wherein, if the monitored increase of the working pressure (ΔP3) is above a first working pressure increase threshold value (ΔP3ₜₕ₁; ΔP3>ΔP3ₜₕ₁) the method comprises the step of:
closing the low pressure valve.

3. The method as claimed in claim 2, wherein the method comprises the step of:
opening one or more injectors arranged to inject fuel into the engine.

4. The method as claimed in claim 3, further comprising one or more steps in the group of:
closing the one or more controllable valves;
activating a regulator fault code;
disabling an ignition system and initiating cranking of the engine; and/or
controlling the engine to work in a special mode, in which a gas volume in an air inlet of the engine and in cylinders of the engine is replaced while an ignition system is disabled.

5. The method as claimed in claim 1, wherein, if the monitored increase of the working pressure (ΔP3) is above a first working pressure increase threshold value (ΔP3ₜₕ₁; ΔP3>ΔP3ₜₕ₁):
the controlling of the permission to crank the engine comprises disallowing cranking of the engine while an ignition system is enabled.

6. The method as claimed in claim 1, wherein, if the monitored increase of the working pressure (ΔP3) is below a second working pressure increase threshold value (ΔP3ₜₕ₂; ΔP3<ΔP3ₜₕ₂):
the controlling of the permission to crank the engine comprises allowing cranking of the engine.

7. The method as claimed in claim 1, wherein the gas fuel system comprises a pressure relief valve arranged to release fuel from the gas fuel system at a set pressure (P_{PRV}), and wherein, between the steps of controlling at least one of the one or more controllable valves such that the gas fuel system is pressurized upstream of the low pressure valve and opening the low pressure valve, the method comprises the steps of:
closing the one or more controllable valves;
monitoring by usage of the at least one upstream pressure sensor a stability of the upstream pressure (P2); and
controlling a permission to crank the engine based on the monitored stability.

8. The method as claimed in claim 7, wherein, if the upstream pressure (P2) is stable, the method further comprises the following steps:
controlling the upstream pressure (P2) to be reduced to the set pressure (P_{PRV}) of the pressure relief valve;
monitoring by usage of the at least one upstream pressure sensor, a stability of the upstream pressure (P2) when reduced to the set pressure (P_{PRV}); and
controlling a permission to crank the engine based on the monitored stability.

9. The method as claimed in claim 8, wherein, if the upstream pressure (P2) is stable at the set pressure (P_{PRV}), the method further comprises the following steps:
controlling at least one of the one or more controllable valves to open, such that the gas fuel system downstream of the one or more controllable valves and upstream of the low pressure valve is filled with fuel;
monitoring by usage of the at least one upstream pressure sensor a stability of the upstream pressure (P2) after the filling; and
controlling a permission to crank the engine based on the monitored stability.

10. The method as claimed in claim 7, wherein, if the monitoring indicates that the upstream pressure (P2) is unstable:
the controlling of the permission to crank the engine comprises disallowing cranking of the engine.

11. The method as claimed in claim 7, if the monitoring indicates that the upstream pressure (P2) is unstable, the method further comprises at least one step in the group of:
determining that a regulator failure is present; and/or
activating a regulator fault code.

12. The method as claimed in claim 9, wherein, if the monitoring indicates that the upstream pressure (P2) is stable after the filling:
the controlling of the permission to crank the engine comprises the step of proceeding to the step of opening the low pressure valve.

13. The method as claimed in claim 1, wherein one or more of the monitored increase of the working pressure (ΔP3), and a first (ΔP3ₜₕ₁) and a second (ΔP3ₜₕ₂) working pressure increase threshold values comprise one in the group of:
an absolute value;
a derivative value; and
a value indicating change over time.

14. The method as claimed in claim 1, wherein the method further comprises the step of,
if one or more initial conditions are fulfilled in the group of:
the at least one working pressure sensor detects a working pressure (P3) below a first working pressure threshold value (P3ₜₕ₁; P3<P3ₜₕ₁), and a vehicle comprising the gas fuel system is in standstill;
the at least one working pressure sensor detects a working pressure (P3) above a second working pressure threshold value (P3ₜₕ₂; P3>P3ₜₕ₂), and a vehicle comprising the gas fuel system is in standstill; and/or
a fault code indicating that the working pressure (P3) has exceeded a third threshold value (P3ₜₕ₃; P3>P3ₜₕ₃) has been activated, and a fuel filling has been performed,
allowing the method to be performed.

15. The method as claimed in claim 1, wherein the method is performed in connection with one in the group of:
maintenance;
a workshop visit; and
when the storage pressure (P1) is below a storage pressure threshold (P1ₜₕ; P1<P1ₜₕ), and an engine fuel consumption (C) is above a consumption threshold (Cₜₕ; C>Cₜₕ).

16. A processing arrangement configured to control a permission to crank an engine, the engine being configured to be provided with a gas fuel by a gas fuel system;
the gas fuel system comprising:
one or more fuel tanks arranged to store the fuel at a storage pressure (P1);
one or more controllable valves arranged downstream of the one or more fuel tanks, respectively, to provide the fuel to at least one regulator at an upstream pressure (P2);
the at least one regulator arranged downstream of the one or more controllable valves to regulate the upstream pressure (P2) of the fuel down to a lower working pressure (P3);
a low pressure valve arranged downstream of the at least one regulator
one or more components arranged downstream of the low pressure valve to provide the fuel to the engine at the working pressure (P3); and
at least one working pressure sensor arranged at the engine;
the processing arrangement being configured to perform the following steps:
closing the low pressure valve;
controlling at least one of the one or more controllable valves such that the gas fuel system is pressurized upstream of the low pressure valve;
opening the low pressure valve;
monitoring by use of the at least one working pressure sensor, an increase of the working pressure (ΔP3) after the opening of the low pressure valve; and
controlling cranking of the engine based on the monitored increase of the working pressure (ΔP3).

17. A computer program product for controlling a permission to crank an engine, the engine being configured to be provided with a gas fuel by a gas fuel system;
the gas fuel system comprising:
one or more fuel tanks configured to store the fuel at a storage pressure (P1);
one or more controllable valves arranged downstream of the one or more fuel tanks, respectively, to provide the fuel to at least one regulator at an upstream pressure (P2);
the at least one regulator arranged downstream of the one or more controllable valves to regulate the upstream pressure (P2) of the fuel down to a lower working pressure (P3);
a low pressure valve arranged downstream of the at least one regulator;
one or more components arranged downstream of the low pressure valve to provide the fuel to the engine at the working pressure (P3); and
at least one working pressure sensor arranged at the engine;
wherein said computer program product comprising computer instructions to cause a computer to perform the following operations:
closing the low pressure valve;
controlling at least one of the one or more controllable valves such that the gas fuel system is pressurized upstream of the low pressure valve;
opening the low pressure valve;
monitoring, by use of the at least one working pressure sensor, an increase of the working pressure (ΔP3) after the opening of the low pressure valve; and
controlling a permission to crank the engine based on the monitored increase of the working pressure (ΔP3).

18. (canceled)

19. A vehicle comprising:
an engine;
a gas fuel system configured to provide fuel to the engine, wherein the gas fuel system comprising:
one or more fuel tanks configured to store the fuel at a storage pressure (P1);
one or more controllable valves arranged downstream of the one or more fuel tanks, respectively, to provide the fuel to at least one regulator at an upstream pressure (P2);
the at least one regulator arranged downstream of the one or more controllable valves to regulate the upstream pressure (P2) of the fuel down to a lower working pressure (P3);
a low pressure valve arranged downstream of the at least one regulator;
one or more components arranged downstream of the low pressure valve to provide the fuel to the engine at the working pressure (P3); and
at least one working pressure sensor arranged at the engine; and
a processing arrangement configured to perform the following steps:
closing the low pressure valve;
controlling at least one of the one or more controllable valves such that the gas fuel system is pressurized upstream of the low pressure valve;
opening the low pressure valve;
monitoring, by use of the at least one working pressure sensor, an increase of the working pressure (P3) after the opening of the low pressure valve; and
controlling cranking of the engine based on the monitored increase of the working pressure (ΔP3).
